(19) United States
(12) Patent Application Publication
(10) Pub. No.: US 2004/0057340 A1
(43) Pub. Date: Mar. 25, 2004

(54) Personal, medical & financial risk management device

(76) Inventors: Joy Charles-Erickson, Houston, TX (US); Ambrose S. Okorie, League City, TX (US); Samson Otuwa, Friendswood, TX (US)

Correspondence Address: THE MATTHEWS FIRM, 1900 WEST LOOP SOUTH, SUITE 1800, HOUSTON, TX, 77027-3224, US

(21) Appl. No.: 10/410,732

(22) Filed: Apr. 10, 2003

Related U.S. Application Data
(60) Provisional application No. 60/371,530, filed on Apr. 10, 2002.

(51) Int. Cl. G04B 47/00

(52) U.S. Cl. 368/10

(57) ABSTRACT

The present invention provides users with a personally managed medical information system and organizer that is standardized and Internet based that is small enough so that it be conveniently worn on the user's wrist. The backbone controlling system software enables the interaction of various sub-components of the present invention for seamless communication and protocol managed data exchange. The present invention provides extensive personal medical history, risk management and other organizational information.

### RELATED APPLICATIONS

This application claims priority from U.S. Provisional Application No. 60/371,530 filed Apr. 10, 2002.

### BACKGROUND OF THE INVENTION

1. Field of the Invention

The present invention relates generally to Personal Medical History & Risk Management (PMH & RM) and more specifically it relates to a personal health & financial risk management/organizer device. The purpose of our invention is to provide users with a personally managed medical information system and adviser in the form of a mobile organizer that is standardized and Internet based and is worn as a wristwatch.

2. Description of the Prior Art

It can be appreciated that PMH & RM devices have been in use for years. Some existing typical examples of PMH & RM devices are as follows:

The CARDEX Watch Alert (WA 1024G) device helps the user to remember medication times. The CARDEX Watch Alert has a very limited function, given the present level of technological advancements. The CARDEX watch is capable of handling only 12 preset reminders per day with an audible alert.

The Digital Wrist Blood Pressure Monitor (TH 350) is a device that helps the user to monitor their blood pressure. The Digital Wrist Blood Pressure Monitor is similarly limited to a very narrow function and has no other medical information about the patient.

The PC Link Cyber Watch (TW 208) is a wristwatch personal organizer/address book device. The PC Link Cyber Watch merely stores address book information.

The Life Alert Device is a medical emergency response system that incorporates a small transmitter and a base-unit for contacting a pre-designated control center for dispatching emergency assistance.

The Medic Alert is a wearable bracelet or necklace label that indicates a user major medical problem, and a number to call for emergency as well as the user code.

The Derek Timex Watch is a conventional digital wrist watch which incorporates an Internet Messenger that allows the user to receive email, headline news, favorite Yahoo Alerts such as stock updates, sports, weather and such public information. The Derek Timex Watch allows for information provided as “raw” data; that is, data that is not specifically relevant to the intended user.

As set forth herein, the health & personal finance risk management device, according to the present invention, substantially departs from the conventional concepts and designs of the prior art. While the above mentioned devices may be suitable for the specific, particular purpose that they each address, they are not as suitable for personal medical history and risk management as provided by the present invention.

The present invention provides an apparatus primarily developed for the purpose intended. Essentially, the present invention provides users with a personally managed medical information system and an organizer that is standardized, mobile and Internet-based.

### SUMMARY OF THE INVENTION

In view of the foregoing disadvantages inherent in the known types of PMH & RM now present in the prior art, the present invention, provides a new health & personal finance risk management device.

The present invention provides a new health & personal financial risk management device that has many of the advantages of the PMH & RM devices mentioned.

The main components of an embodiment of the present invention includes:

1. a memory storage device, preferably a 20 MB Flash Memory Unit;

2. a microprocessor;

3. a memory interface device;

4. a timing device for indicating current data and time including an alarm unit;

5. a programmable personal organizer;

6. a blood pressure and heart hate monitor unit;

7. a Liquid Crystal Display (LCD) unit;

8. a USB powered docking station;

9. a wireless receiver unit;

10. a power supply device;

11. input keys or other input devices; and

12. an operating system controller;

The memory storage device can be used for storing personal records, vital medical information, current prescriptions & history of medications over the past 18 months.

The alarm/vibration unit preferably comprises a combination of an audible alert system and a vibration alert system for medication and/or other reminders and warnings for low battery power indications.

The blood pressure monitor preferably comprises a device subsystem that monitors the user's blood pressure at predefined times in a day, tracks values over a predetermined period as well as computes the average values for the current period within its processor.

The LCD array preferably comprises a backlit digital 4×18 LCD Array with a unique display technique uses over 1.8″×1.5″ display area.

The base unit/cradle make it possible to rapidly program or reprogram the device. It can also be programmed by use of the Internet site from which information can be downloaded. Further, it can be programmed offline from a Personal Computer (PC) at home or doctor's office. The unit base cradle is an optional integral unit for rapid online updates. It facilitates for pre-programmed features or selections such as stock ticker updates with specialized calculated value indicators over a period of 30-days, credit card charge alerts with amounts and balance tracking (notification activation required with bank/Credit Card company).

An Operating System Controller is comprised of controlling system software that provides the backbone of the device design. It enables for the interaction of various sub-components of the present invention to seamlessly communicate with appropriate protocol that managed information/data exchange.

A real-time internal clock provides the time-keeping function is performed by the real-time clock, which features a stopwatch, and regular alarm as well. With software enabling over the Internet, or a PC running the Atomic Clock synchronization software, it is capable of keeping very accurate time.

The keypad/function keys of the present invention features a keys/buttons for it's operation. Preferably, these include: RW (EMG), BI (HST), and B2 (LDG) (for emergency data access, basic Medical History information retrieval, and routine limited information loading/display, respectively. It features a pair of toggle-based cursor movement keys (LF/RT, and UP/DN), which are used in combination with press-button function side keys (B1/B2), are available on the present invention.

The programmable personal organizer preferably comprises an integrated personal organizer system. The personal organizer system consists of an address book, a calendar, an expense tracking subsystem, and selected stock values with calculations. The stock values can be updated at various times daily from the Internet. A moving average may be generated for stock values over a specified period. The Personal Organizer of the present invention provides extensive personal medical history divided into two areas, namely, basic and major medical including: (1) the basic includes: current medications or prescriptions with their associated diagnoses; regular physician's name/contacts; other/secondary physician's name/contacts; social security number; Insurance Providers/contacts; Emergency contacts/next-of-kin; DOB; blood type & recent blood panel/counts; important dental history/profile; Organ donor information, links to family members/history of certain conditions, etc.; and (2) the major medical includes EKG information; major surgeries, etc.

Optionally, the present invention is equipped with and provides access to (by Internet Web Portal) biblical scripture references which can be applied in the user's life.

From the foregoing there has thus been outlined, rather broadly, the more important features of the invention in order that the detailed description thereof may be better understood, and in order that the present contribution to the art may be better appreciated. These as well as additional features of the invention that will be described hereinafter.

In this respect, before explaining at least one embodiment of the invention in detail, it is to be understood that the invention is not limited in its application to the details of construction. Nor is it limited to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the present invention. (Includes the top/side profile).

FIG. 2 is a bottom view of the present invention.

FIG. 3 is an exploded view of the present invention showing a typical display of the LCD components.

FIG. 4 is a functional block diagram showing the functions of the present invention.

FIG. 5 is Subsystem layers and operations hierarchy.

FIG. 6 is FIG. 6.1(a-c) the present invention Web Portal Home pages (Welcome, Registration, General Information Entry).

FIG. 7 is FIG. 6.2(a-e) Privileged Information and Medication Alert Setup pages.

FIG. 8 is FIG. 6.3 Personal Organizer—Sock Selection/Edit.

FIG. 9 is FIG. 6.4(a-c) Expense Tracker/Credit Card Monitoring pages.

FIG. 10 is Table 1: Logic Table of Hardware Functions.

TABLE 1
Logic Function Table

| RW | B1 | B2 | UP | DN | LF | RT | Function Description/Action |
|---|---|---|---|---|---|---|---|
| 1 | 0 | 0 | 0 | 0 | 0 | 0 | Holding down for 10 sec. = EMG Info Display |
| 0 | 0 | 1 | 1 | 0 | 0 | 0 | Enter Edit Mode |
| 0 | 0 | 1 | 0 | 1 | 0 | 0 | End or Exit Edit Mode |
| 0 | 0 | 1 | 0 | 0 | 0 | 0 | Jump between window panes in Edit Mode |
| 0 | 1 | 0 | 0 | 0 | 0 | 0 | Deletes Character at the cursor in Edit Mode |
| 0 | 1 | 0 | 0 | 0 | 0 | 1 | Deletes word at the cursor in Edit Mode |
| 0 | 0 | 1 | 0 | 0 | 1 | 0 | Enter Scheduler Sub-Mode in the “PO” Mode |
| 0 | 1 | 0 | 0 | 0 | 0 | 1 | End/Exit from an mode when in “PO” Mode |
| 0 | 1 | 1 | 0 | 0 | 0 | 0 | Enter “PO” Mode (Hard-wired) |
| 0 | 1 | 0 | 1 | 0 | 0 | 0 | Enter Expense Tracker Sub-Mode in “PO” Mode |
| 0 | 1 | 0 | 0 | 1 | 0 | 0 | Enter Address Sub-Mode in “PO” Mode |
| 0 | 1 | 0 | 1 | 1 | 0 | 0 | Enter Calculator Sub-mode in “PO” mode |
| 0 | 0 | 1 | 0 | 0 | 1 | 1 | Enter Credit Card info in “PO” mode |
| 0 | 1 | 0 | 0 | 0 | 1 | 0 | Enter the “Life Adviser” mode for Bible & |
| | | | | | | | knowledge search, words of wisdom/keys to life |

### DETAILED DESCRIPTION OF THE PREFERRED EMBODIMENT

Turning now descriptively to the drawings, in which similar reference characters denote similar elements throughout the several views, the attached figures illustrate a health & personal finance risk management device, which comprises the following.

The main components of the invention include: (a) a 20 MB Flash Memory Unit; (b) Alarm/Vibration Unit; (c) Programmable Personal Organizer; (d) Blood Pressure & Heart Rate Monitor Unit; (e) A unique LCD Display Unit It is a backlight digital 4×18 LCD Array with a unique display technique used over 1.8″×1.5″ display area; (f) USB powered Docking Station; (g) Wireless Receiver Unit is used for storing personal records, vital medical information, current prescriptions and history of medications; (h) a combination of vibration and audible alert system for medication reminders and warnings for low battery power indication; (i) an integrated personal organizer system consisting of address book, calendar, expense tracking, and selected stock values/calculations; (j) A device subsystem that monitors the user's blood pressure at predefined times in a day, tracks value over 90 days as well as computes the average value for the current week within it's Compute Engine; (k) a base for rapid programming or reprogramming of the device using the Internet site or offline from a Personal Computer (PC) at home or doctor's office. It is an optional integral unit for rapid online updates for pre-programmed features or selections such as stock ticker updates with specialized calculated value indicators over a period of 30-days, credit card charge alert with amounts and balance tracking (notification activation required with bank/Credit Card company); (l) the backbone controlling systems software enables the interaction of various sub-components of the present invention for seamless communication and protocol managed data exchange; (m) the time-keeping function of the present invention is performed by the real-time clock. It features a stopwatch and regular alarm, as well. With software enabling over the Internet, or a PC running the Atomic Clock synchronization software, it is capable of keeping very accurate time.

The present invention provides extensive personal medical history divided into two areas: basic and major medical. An embodiment comprising a basic unit includes: (a) current medications or prescriptions with their associated diagnoses; and (b) regular physician's name/contacts; other/secondary physician's name/contacts; (i) social security number; (ii) insurance identification/contacts; (iii) emergency contacts/next-of-kin; (iv) DOB; blood type & recent blood panel/counts; (v) Important dental history/profile; and (vi) organ donor information, links to family members/history of certain conditions, etc.

The major medical includes EKG information; major surgeries in past 10 years, etc. The present invention feature a few keys/buttons for it's operation.

a. These are: The present invention Logo, EMG, HST, and LDG (for emergency data access, basic Medical History information retrieval, and routine limited information loading/display, respectively.

b. A pair of toggle-based cursor movement keys (LF/RT, and UP/DN), which are used in combination with press-button function side keys, are available on the present invention.

The memory unit, preferably a flash memory unit (FMU) is used for storing personal records, vital medical information, current prescriptions & history of medications over the past 18 months. The flash memory unit is the storage or brain of this device. It stores all the information and can be re-written as many times as necessary by a user, or the managing physician/doctor. All information downloads from a PC or via the Internet are stored in this memory unit. It is akin to the early versions of EPROM (Erasable Programmable Read Only Memory) device. (See the Functional Block Diagram in FIG. 4—Software modules are encapsulated in the Flash Memory Unit. Also FIG. 5—Systems Design Layers for Hardware and Software shows how the Flash Memory span across both the physical hardware layer at the bottom and the software layers—the next 3 levels in the design hierarchy). The Flash Memory Unit is a Read/Write (R/W) device. It picks data written to it from the keypad function entries, the PC via the USB based docking station, or via the Wireless technology from the Internet.

The present invention also comprises a combination of vibration and/or audible alert system for medication reminders, and warnings for low battery power indication. The alarm unit produces two kinds of alarm based on the settings and the two possible actuating sources. (See the Functional Block Diagram in FIG. 4). A first source is the software that monitors time-based alert settings for medication. The second source is the battery/power hardware threshold monitors which sends a trip signal during low power delivery. In each of the cases, a choice of alarm/alert in the form of a vibration or audible beep is user selectable within the device controlling software. The alarm unit receives control signals from the present invention Controller to either sound an alarm or vibrate an alert for the user. Thus, two controlling signals are only necessary for it to function. A digital 11 makes it sound an audible alarm and a digital 01 makes it vibrate. Its two outputs go to the integral beeper and vibrator modules, respectively. The alarm unit generally comprises two functional parts that emit an audible alert and/or uses excessive frequency to generates a vibration alert.

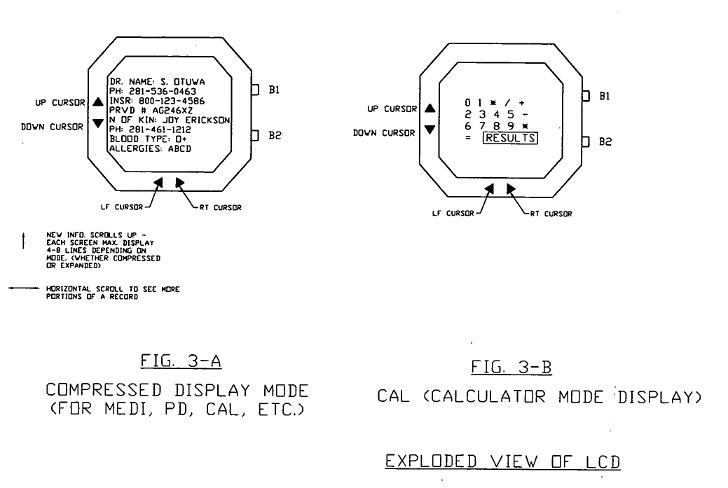

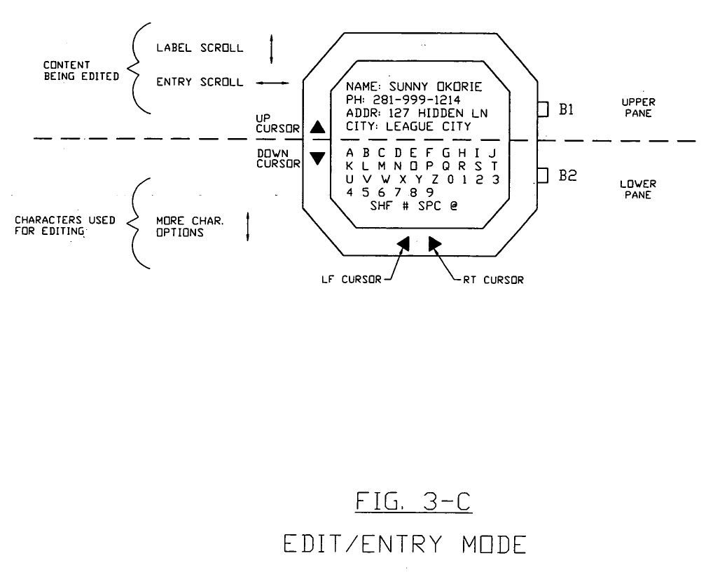

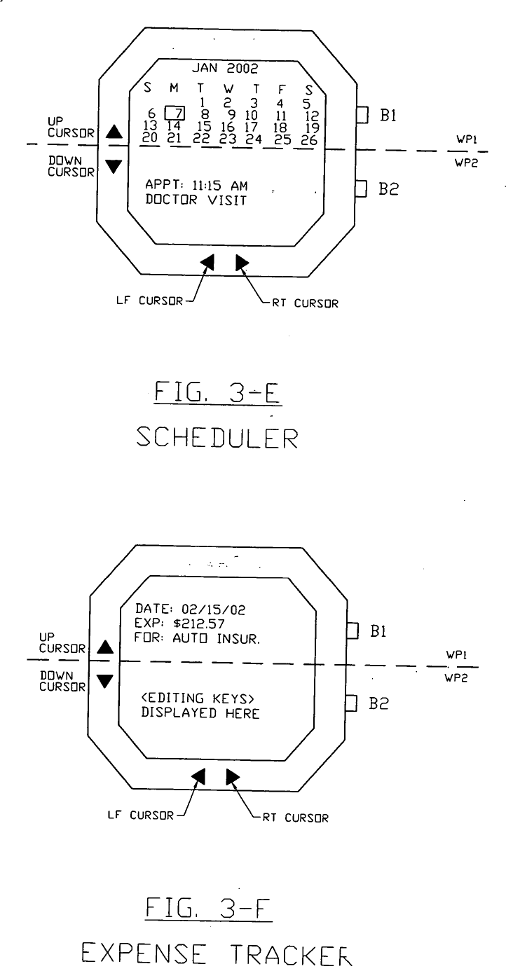

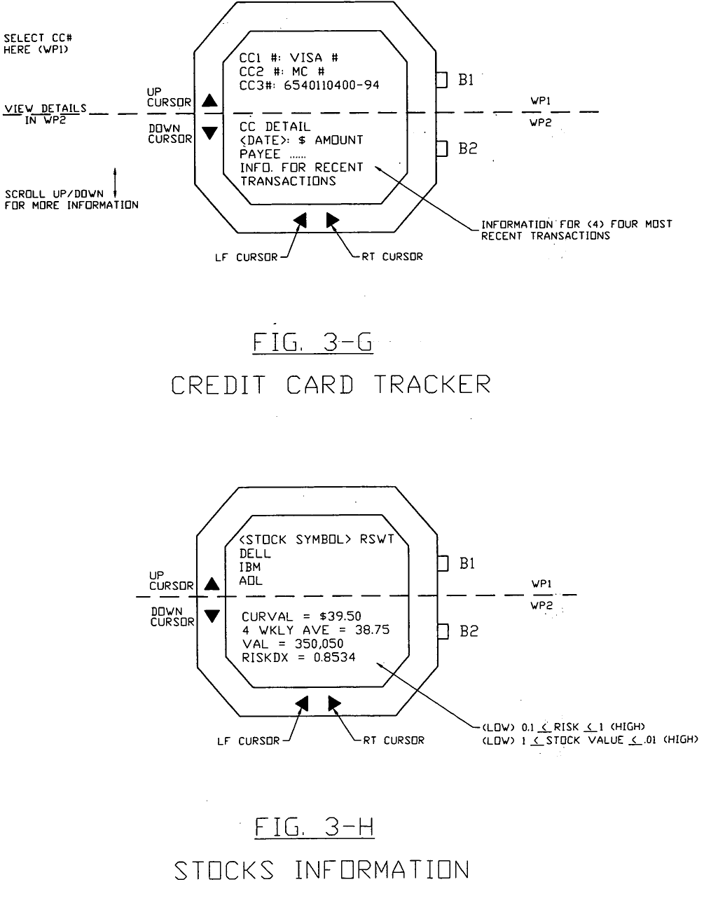

An integrated personal organizer system consisting of address book, calendar, expense tracking, and selected stock values/calculations tracking updated 2-3 times daily from the Internet. A moving average may be generated for up to 10 stock values over a 30-day period. The Personal Organizer, in its loaded version, has the following functional programmed modules: (1) A Scheduler—allows a user to set appointments with optional alerts/reminders; and (2) An Address/phone/email address/short memos book—for storing the contact information of family, friends, & associates. To switch to displaying addresses and phone numbers or memos, the user holds down button B2, and then presses B1 once. The user will then be prompted to view, add, edit, delete a contact's name, address, phone, email, etc. The user can then use the scroll keys to navigate through the menus. If the “Add”, “Edit” or “Delete” sub-function is selected, (the Display Unit is shown in FIG. 3c) the upper half of the window pane (upper 3 rows) will show the elements being programmed or changed, while the lower 5 rows provide the data characters (a-z, 0-9, Sht, *, #, @, Spc, etc) used in making the desired change.

In the example shown in the display: the items being changed are:

1. “Name”—Sunny Okorie

2. “Phone”—281-538-8832 (Different # from FIG. 3c)

3. “ADR:” 127 Hidden Lake Drive, League City, Tex. 77853. The operator only sees “127 Hidden” for the street address. The operator may scroll “RT” with the scroll right button to see the rest of the address. At this time, it is possible to stop at any character and replace or change it with a desired character from the bottom half of the screen.

4. To delete a character at the cursor, the operator must stop scrolling at that character and then press “B1”.

5. To delete a word, the operator must move the cursor to the word and, press “B1” immediately after pressing the “RT” key simultaneously.

6. The “B2” key is used to switch the cursor between the upper and lower window panes (i.e. Data Value pane/Character-To-Use pane, or upper and lower portions of the Display Unit).

An Expense Tracker software package may also be included in the present invention for tracking and accumulating daily personal expenses (user entry required, or Credit Card/Bank Card expenses for registered cards at the present invention's name.com Web Site).

Also, a simple calculator for personal arithmetic may also be included as a software package. (See FIG. 3b—CAL Mode of the Exploded View of LCD).

Additionally, a stock tracker/ticker update with low value alert that provides an average value of up to 10 company stocks over a period of 30 days along with volume and risk indicators that help users decide to sell, keep, or buy. In the PO mode, the Display Unit displays information. In the Compressed Mode, as shown in FIG. 3a, each major item is prefixed with its corresponding value. For example, “Stock:” Name1: $value; 30-day $Avg.; Volume. “Exp:” Item Name: $value spent on item; “Export:” $Total of Expense for current date; “Epson:” $Total of Expense in the current Month.

Also, Credit Card Name can track Expense. For example, if a user is signed up for the present invention Web Portal, and has a Discover card as well as Visa card account registered, the charges and outstanding balance on these cards can be uploaded to the present invention for tracking. To display them in the “PO” mode, while holding down B2, press B1 twice to retrieve and display all Credit Card Expenses with current balances as of last download/synchronization with the user Internet records.

The present invention also comprises a device subsystem which monitors the operator's blood pressure at predefined times, tracks values over a predetermined number of days, and also computes the average value for the current period within the inventions processor. The blood pressure/heart rate monitor performs two important functions in this embodiment. The monitor generally has two sensors/transducers that measure the heartbeat and blood flow pressures when worn properly over (the opposite side of) the wrist. The device incorporates some A/D (Analog to Digital conversion) mechanism that presents the values to the present invention's controller. These values are then mathematically configured and stored until they are needed.

On demand, the present invention will provide users with current and historical information about their blood pressures and heart rate, over preset time periods in the day. The default setting take these readings 6 times a day (2 in the morning—8 AM, and 10:30 AM; 2 in the afternoon—1 PM, and 3:30 PM; and 2 in the evening—6 PM and 8:30 PM).

The backlight digital 4×18 LCD Array with a unique display technique used over 1.8″×1.5″ display area. The LCD Display Unit of the present invention is an advanced backlit display. It is a 4 line by 18 character display in its standard mode. This makes it easily readable by people of all ages. It displays the following information:

Current time and date setting;

Stop clock timing when activated;

Personal Medical History Information—when in “MED”/“HST” mode;

Medical emergency information—when in “EMG” mode: Doctors' name/contact information, insurance policy data, and/or other vital emergency information.

The Personal Organizer (PO) allows the user to access information in “PO” mode, whereby the “B1” button, when depressed, provides the character sets (A-Z, a-z with space, dash, slash, etc.). The “B2” button is used for numeric entries from 0-9 by repeated presses to cycle through the numbers or characters. In the Calculator sub-mode of “PO”−“CAL” the entire display turns into a calculator keypad. The cursor keys are then used to move to desired functions or numbers with “B1” for selection, and “B2” used to exit the mode when done. The “=” sign is a selectable item via cursor movement. The bottom row of the LCD window is used to write results of any calculator operation. It has 2 display modes—expanded mode, and compressed character display mode. In the Expanded mode, we have 4 rows of larger character display with a maximum of 18 characters per row. In the compressed mode, we have 6 rows of 24 characters per row (smaller display).

An optional docking station provides a base for rapid programming or reprogramming of the device of the present invention using an Internet site or offline from a Personal Computer (PC). Preferably the docking station is USB powered and used to physically connect or link the present invention to a PC. It serves as home base for downloading data into it and rapid programming using the custom software that comes with this optional device. This device has an electrical contact port that interlocks with a matching notch on the bottom side view of the present invention for program downloading.

An optional integral unit for rapid online updates for pre-programmed features or selections such as stock ticker updates with specialized calculated value indicators over a period of 30-days, credit card charge alert with amounts and balance tracking (notification activation required with bank/Credit Card company).

An optional wireless receiver device receives information from an internet portal to update personalized user data or provide pre-selected information options and preferences of the user with respect to stocks, credit card expense information, etc. This portal is preferably powered by the Blue tooth wireless technology/Motorola implementation using the IEEE 802.11b standard for wireless communication.

The backbone controlling systems software that enables the interaction of various sub-components of the present invention for seamless communication and protocol managed data exchange. The present invention's OS (Operating System) Platform is the bedrock of its controlling software. It is Windows CE or Linux based depending on platform implementation decisions. The OS interfaces between the various hardware components and the software programs written to control each device and produce required information or signals. For example, the software that implements basic alerts for medication reminders generates a software interrupt based on the real-time clock and the settings chosen by the user to designate the times when medications are to be taken. The interrupt signals are then used to actuate the buzzer or vibrator to deliver the required reminder signal to the user as requested. Another example is the reception of wireless signals from the Internet Portal. The wireless packets received are converted to digital signals and interpreted by the OS controlling software. All models have an OS subsystem platform.

The present invention's time keeping function is performed by the real-time clock, which features a stopwatch and a regular alarm as well. With software enabling over the Internet, or a PC running the Atomic Clock synchronization software, it is capable of keeping very accurate time.

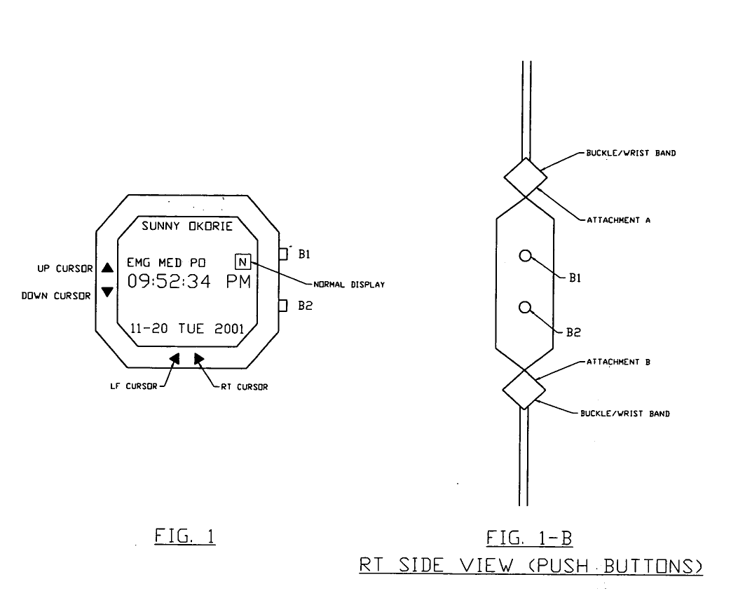

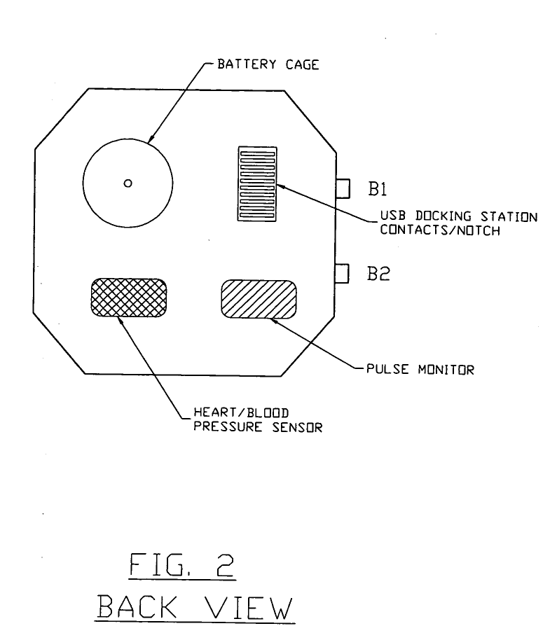

The Digital Time Piece simply provides and displays the real-time clock values of the system. A crystal oscillator generates the time with millisecond long interrupts counted down to the second value. A second storage area in memory count up from 0 to 59 seconds to cause the minutes storage area to be incremented by 1. The minute's counts up from 0 to 59 and then increments the hour's storage area. The hours count from 00 (mid-night) to 23:59:59 (military/24-hour time). If settings are for 12-hour clock, the hour's storage area shifts it's counting range from 00:59 to 11:59:59 (Noon) with a second bumping it forward to the first hour. The digital time is displayed using the standard miniaturized backlit LCD technology. When RiskWatch of the present invention downloads data the first in any day to synchronize with the present invention Web Portal for the user, it simultaneously synchronizes the real-time clock to the Atomic Clock in Denver, Colo., thereby ensuring very high degree of accuracy, or time precision. The Digital Time Clock display example is shown in FIG. 1.a for a current time of 09:52:34 PM with a current date of 11-20 TUE 2001 (i.e. November 20, Tuesday 2001. All models are basically the same internally.

The present invention provides extensive personal medical history divided into two areas: basic and major medical. Basic medical history includes the following:

current medications or prescriptions with their associated diagnoses;

regular physician's name/contacts;

secondary physician's name/contacts;

social security number;

Insurance identification/contacts;

Emergency contacts/next-of-kin;

Date of Birth (DOB);

blood type & recent blood panel/counts;

important dental history/profile;

Organ donor information;

links to family members; and

history of certain conditions, etc.

Major medical includes EKG information; major surgeries in past 10 years, etc. The Personal Medical History Records kept by the present invention are as follows:

A. General Information about User

1. Name and date of birth.

2. Address and phone number

3. Allergies

4. Next of Kin (Name and phone number).

5. Primary Physician (Name and phone number).

6. Blood type

7. Average weekly Blood Pressure (ABP)

B. Privileged Information about User (Requires Access Pin#)

1. Social Security Number.

2. Significant medical history of user

3. Significant family history (any major illness that run in family, or cause of pre-mature death of close blood relatives).

4. Medications (current—by names/prescription dosage regimes).

5. Prescription Medications taken in past 12 months by names & dosage (if known).

6. Most recent care—Diagnosis and Treatment.

7. Past Surgical History.

8. Most recent EKG (if any).

9. Dental Profile

10. Miscellaneous Notes or information.

The Display Unit switches to Compressed Mode to display all Medical Information with all scroll direction capability as shown in FIG. 3.a—the Exploded View of the LCD. Models A & B do not have item A-7, B-3, B-5, and B-10 due to some related unavailable features or memory capacity in their internal structures.

The present invention features a few keys/buttons for it's operation. The keys include:

EMG, HST, and LDG (for emergency data access, basic Medical History information retrieval, and routine limited information loading/display), respectively;

A pair of toggle-based cursor movement keys (LF/RT, and UP/DN), which are used in combination with press-button function side keys, are available on the present invention. The present invention's design is simple;

It has two physical press button switches—“B1” and “B2” for various functions, two UP/Down (DN) cursor movement keys, and two LEFT (LT)/RIGHT (RT) cursor movement keys. (See FIG. 1a—Normal Display Mode; and 1b-Side View of the invention);

Logo button (RW)—is used to display “emergency information” for the owner. It is also used in conjunction with other key/buttons to perform certain functions;

Their functions are defined as follows:

“B1”—Advance the values for item highlighted;

“B2”—Execute the selected function or operation (equivalent to the “=” in the CAL mode);

“UP/DN” arrow keys to move up or down on the display unit (see key on left side of FIG. 1a);

“LT/RT” arrow keys to move left or right on the display unit (see key on bottom end of FIG. 1b).

For the Calculator mode display see FIG. 3b-Exploded view (CAL Mode). Another set of function keys implemented in software but selectable with the “B1/B2” push button switches are “MED” for Medical/Personal History; “EMG” for Emergency data demand; the “PO” for Personal Organizer mode, and the “N” for Normal operating mode and display as shown in FIG. 1a.

Further, the present invention has the Calculator functions (+, −, /, and x) in “Soft” implementation displayed in the “CAL” mode (FIG. 3b). In this mode, basic calculation of most arithmetic expressions can be done with results displayed at the bottom row window left of the “=” sign as shown in FIG. 3b.

The interconnection of the subsystems is shown in the Functional Block Diagram of the present invention of FIG. 4. The hierarchy for interaction is also depicted in FIG. 5—System Hardware and Software Layers that also show how the present invention links via Wireless communication with its Internet Portal.

At the heart of the system is the hardware layer consisting of the following:

a. A Real-Time Clock.

b. An Alarm Unit/Vibrator

c. A Heart Pulse Sensor (with A/D Converter).

d. A Blood Pressure Sensor with A/D (Analog to Digital Converter/interface).

e. A Power Supply Unit (battery with minimum of 6 months life span) 3 mWatts, 3.5 V Li-ion.

f. A Wireless receiver—IEEE 802.x compliant technology (Motorola or Blue tooth).

g. An LCD Display Unit/Memory Unit—PDA/Flash Memory/EPROM unit. The LCD is basically an output device that receives information from any other device and displays what signal or information it receives. The software subsystems—from systems control (the Operating System—Win CE/Linux OS) to the application software (Personal Organizer: Calculator, Scheduler, Expense Tracker; Person Medical History/Medication reminder, etc) are developed, and encoded onto the EPROM chipset or PDA Flash Memories for the present invention specific functions. The flow of information/signals is also shown in the diagram of FIG. 4 to illustrate how the subsystems work together to achieve the desired goal of the present invention as a vital person assistant or life support tool. The alternative variations of the invention are covered in the “Description” variations for Models A, B, and C of the present invention.

To initiate the present invention, power must be provided to the system (i.e. install the battery and hold down the “B1” and “B2” buttons for about 10 seconds, the system is initialized). System Initialization/Default State Initialization of System means that it is reset to factory condition.

In this state, the Clock will display present time as just seconds past midnight. The invention of the present invention will also display preset date stored in the devices' memory.

Above the time and date will be the default the present invention Owner's first and last name: “Sunny Okorie” (All Men's models) or “Joy Erickson” (All Ladies models). Internally, there is no other difference between the men's and ladies models. The difference is in the external feature or look and feel.

Also, immediately below the default owner name will be found the four main operating modes of the present invention with the cursor blinking under “N” (Normal) mode. The other modes shown in FIG. 1a are EMG, MED, and PO. Any of these may then be selected for operation using the buttons and the cursor movement keys.

To view basic medical records in the event of emergency or when the owner is unable to communicate with health care practitioner, the operator may press and hold down the “present invention's” logo button for 5 seconds to display the following:

1. Name, SSN, name and phone number of closest relative on first window

2. Primary physician's contact and Insurance Provider information on next window

3. Allergies of patient on 3rd window and blood type

4. Most recent diagnoses on 4th window

5. Current medications user is taking on 5th window. Diabetic profile data and Blood Pressure data averages are displayed on subsequent page down functions from this window as well. Step from one window to the next using the “UP/DN” arrow buttons—the “UP” to go to previous window, and the “DN” to go to the next window in the “the present invention” mode. During data load into the device, the Operator has the privilege to override what gets displayed in Emergency Mode should they become unconscious, or in an accident where any other person/stranger may have access to this feature. (As a result, Owner's privacy rights are not violated as they balance their own risks against personal privacy requirements).

To add/edit the Owner's name information do the following: FIG. 3.c is an exploded view of the Edit/Entry mode. To add or change the name displayed on device, hold down the “B2” button and the “UP” cursor button for 3 seconds. Two Edit windowpanes will appear. The cursor will start blinking under character “a” in the lower pane. The upper pane will show “Name:” followed by either the default name (Sunny Okorie), or the name that was previously entered.

To jump between the two windowpanes the operator must press the “B2” button. While in the upper pane, the cursor key to move to the first letter of name “Sunny”. The operator is now ready to change/replace the preset name.

To go to the lower pane and select a character to replace names with, beginning at “Sunny”, the operator should press the “B2” button again. For example, if the operator wishes to enter “Timothy”, navigate to T, then I, followed by the rest of the letters that form Timothy. As the operator enters each one, it is reflected in the upper pane on character at a time.

When the full name of the operator has been entered, the operator presses the “B1” and “DN” buttons at the same time to enter the data.

To set date and time, the operator should press the “RW” and “LF” or “RT” at the same time to Start or End the Date and Time setting mode. Thus, pressing “RW/LF” starts the time and date blinking and ready for change.

The operator may use the normal Editing functions to change time and date as desired.

Pressing the RW/RT buttons at the same time ends the Date and Time setting mode.

To use the MED mode for entering “General Information” the operator must manually follow the following steps:

1. Briefly press “RW” and “B1” buttons (for approximately 1-3 seconds) simultaneously to display enter medications or general information about patient/operator.

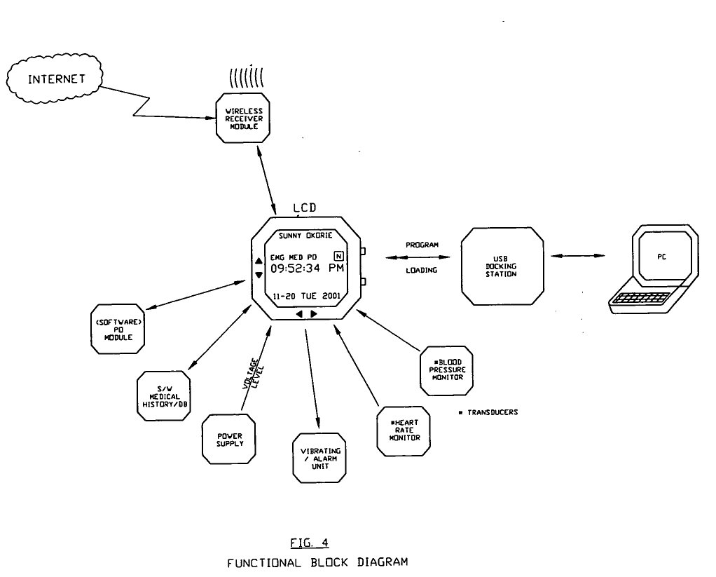

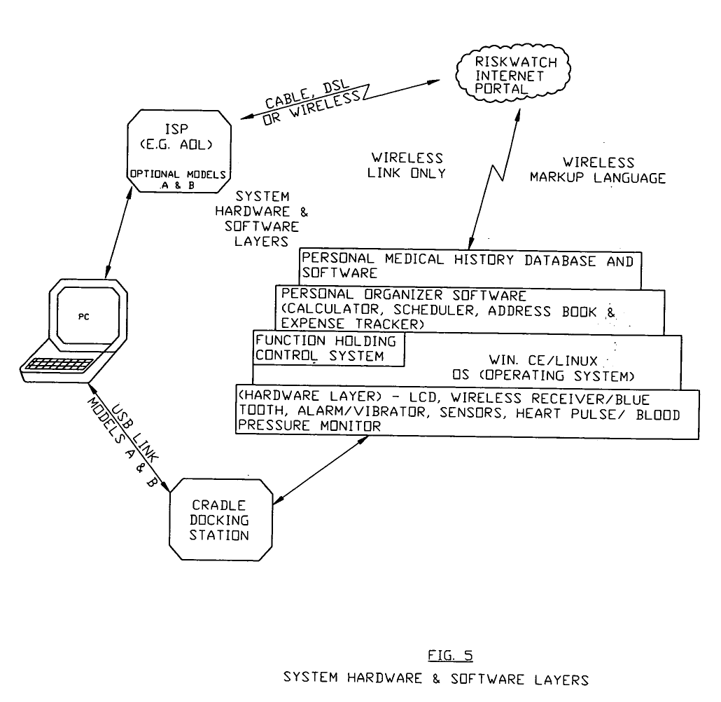

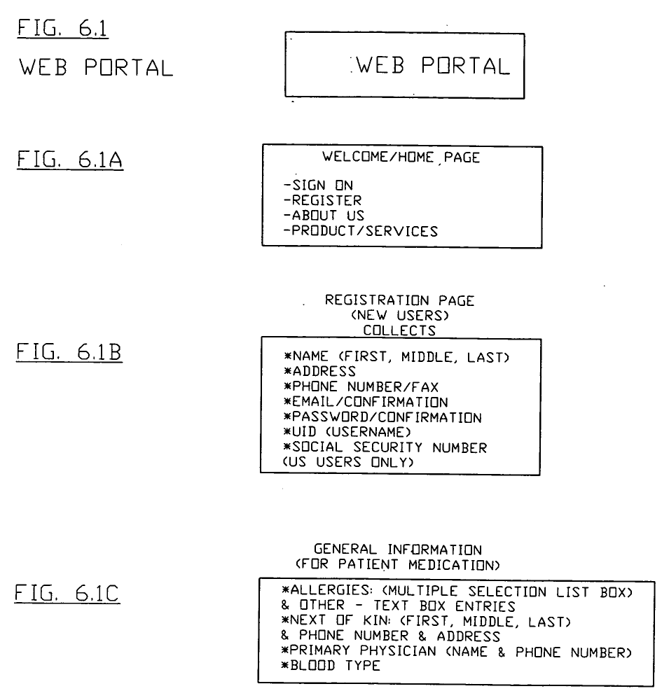

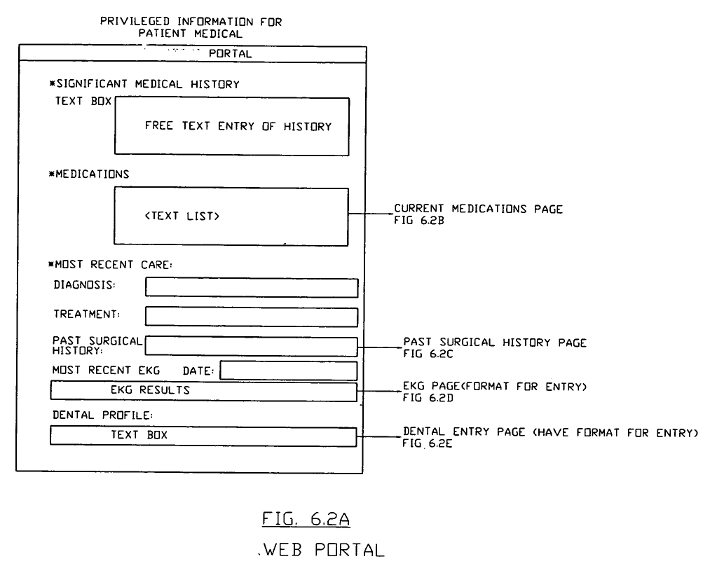

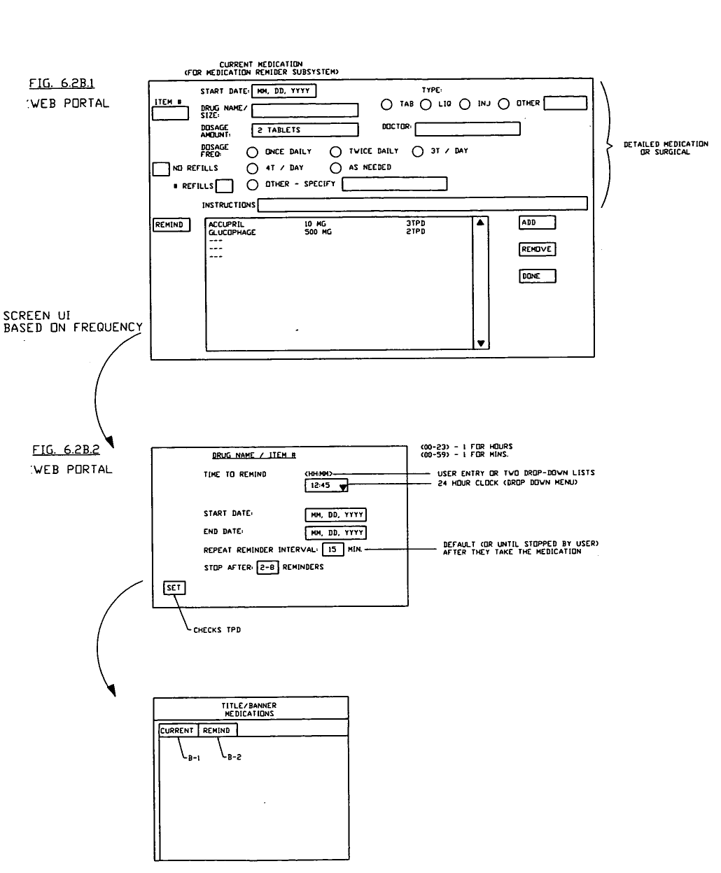

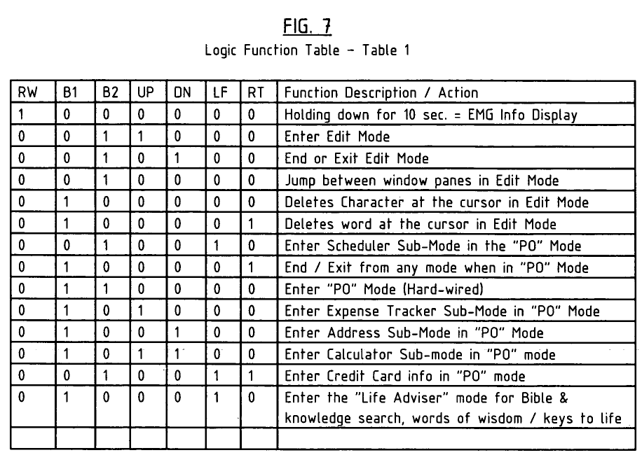

2. The standard editing keys/functions may be used to view/navigate or change the medication data. (Note: As one scrolls to the end of General Information section, the information is organized as shown in the corresponding Web Pages—See FIG. 6.

3. The mode is ended by pressing the “RW/UP” combination at the same time.

To use the MED mode for entering “Privileged Information” manually the following steps must be followed: (Note that the information stored here is protected with pin# you set or select during this setup—we recommend the 4 digits of your year of birth in order to help your doctor, or family members to easily recall these data in case of emergency)

1. Press and hold “RW/BI” for longer than 5 seconds to enter this mode;

2. Respond to the prompt by entering your 4-digit pin# or ID selected during setup in the upper windowpane (WP1).

3. Position the cursor at the lower window pane (WP2) to select the numbers from the digits/characters displayed in the WP2 pane. Use the cursor movement keys to navigate as usual, and the B1 button to make the selections/fill in the fields in the WP1 pane. Note: 3 attempts are allowed for password entry.

4. When correctly entered, the “Privileged Information” is displayed in the “WP1” pane for viewing/or editing as usual.

5. End the mode by pressing the “RW/UP” combination at the same time.

To provide vital information for emergency contacts for user in EMG mode, follow the following steps:

1. Hold down the RW button for 5-10 seconds to display all the vital emergency information.

2. Scroll down and up with the cursor movement keys UP/DN or LT/RT as desired to view the information.

3. When done, repeat step 1 to end the mode (toggle switch mode) by holding RW down again for 5-10 seconds.

To use the PO mode for add/edit/delete: Address Book contact info, follow the following steps:

1. Press the B1/DN button at the same time to initiate the Personal Organizer mode.

2. Once in this mode . . . several sub-modes become available for entry and other functions. They are: CAL (Calculator), Expense Tracker, Credit Card information view, Scheduling appointments, etc.

To use PO mode for Calculator—CAL, follow the following steps:

1. Press B1/UP And DN to initiate the use of your present invention Calculator.

2. Follow the on-screen display to enter and manipulate your numbers—see the FIG. 3-B.

3. When done, press the toggle switch RW to return to normal mode.

To use PO mode for scheduling appointments in Calendar (FIG. 3-E), follow the following steps:

1. Press B2/LF to open the Calendar sub-mode.

2. Find the desired date in the current month displayed. Use the cursor keys to advance to the date. If another month is desired, press B2/UP or B2/DN to go forward a month, or backward one month.

3. Press B1 to mark the date desired.

4. The current Time will display in the lower pane (WP1) with a blinking cursor on the hours digits. Press B2 to advance the hour, or LT/RT button to move to minutes/back to hour of the day for the schedule.

5. When time is set, press B 1 to mark the time. Notice that hours are in military time or 24-hour clock to avoid having to worry about AM and PM.

6. The cursor will then be positioned in the second field below time called: Memo

7. Use the Memo field to enter a short reminder text for this appointment, like: “Visit Dr. Smith—Medical Center”, or “Leave for Meeting with Lanny Erickson & VP”.

8. When done with the Calendar Scheduler, press RW to return to normal mode.

To use PO mode for Expense Tracker (FIG. 3-F), follow the following steps:

1. Press B1/UP buttons at the same time to enter this mode.

2. Your expenses recorded earlier are immediately available for view in the WP1 pane.

3. Use the cursor movement keys/editing functions to change or add new expense item.

4. To add a new expense item, scroll to the end of the expense list and use the next 3 fields for a) date the expense was made b) a short description of the expense (less than 20 characters), then c) the amount in $ or your currency.

5. When done, press RW to end the mode and return to normal display.

To use PO mode to get or display your Credit Card info (after registering at the present invention's Web Portal) follow the following steps:

1. Press B2 and the LF/RT together to initiate this mode.

2. Your existing Credit Card records will display by the card numbers/type.

3. Move the cursor with UP/DN key to select the one desired for detail report.

4. Press B1 to select and pull the details on that card.

5. The detail is displayed in the lower window pane WP2 showing most recent charges to the card up to transactions in the last 30 days downloaded into the present invention.

6. If you have no activities, it shows the message “no activities to display”.

7. Use B2 to jump between panes WP1 and WP2—see FIG. 3-G.

8. End the mode by pressing the toggle switch RW to return to normal display.

To use PO mode to track Stock (after signing up at the present invention's Web), follow the following steps:

1. Press RW/B2 at the same time to display your stock items, their current value, and the computed average values over past 4 weeks including trading volumes, and a decision index to keep, buy, or sell.

2. Use the cursor movement keys to scroll through the numbers and Window panes. Note: Details of a selected thicker item are shown in the lower window pane, WP2, similar to Credit Card displays in FIG. 3-G.3.

3. Press RW to end the mode and return to normal display.

As to a further discussion of the manner of usage and operation of the present invention, the same should be apparent from the above description. Accordingly, no further discussion relating to the manner of usage and operation will be provided.

It is to be realized that the optimum dimensional relationships (for the parts of the invention, including variations in size, materials, shape, form, function/manner of operation, assembly and use) are deemed readily apparent and obvious to one skilled in the art. Any equivalent relationships to those illustrated in the drawings and described in the specification are encompassed by the present invention.

Therefore, the foregoing is considered as illustrative only of the principles of the invention. Further, numerous modifications and changes will readily occur. It is not desired to limit the invention to the exact construction and operation shown and described, and accordingly, all suitable modifications and equivalents may be resorted to, falling within the scope of the invention.

I claim:

1. A personal multifunction portable device compact capable of being worn on a human forearm comprising:
a display screen controller including a display screen;
a no/don's select switch and a yes/select switch on said device as the means for entering data, manipulating data and/or controlling navigation through a tree of data menus displayed on the display screen and for selecting specific menu items displayed on said screen, said yes/select switch disposed on said device at a position separated from said no/don't select switch for entering of the selected menu items as field generated data by said user;
a time keeper device for generating time and displaying the time and time on the display screen;
an electronic read/write data storage system comprising a non-volatile memory having stored therein said tree of data menus;
a system controller including a microprocessor for executing at least one software program to display said tree of data menus on said screen, and scan, read only, select and write from said tree of menus in said data storage system;
a system battery operatively connected to said system controller, said data storage system, and said display screen;
a communications port to allow said device to be connected to a computer for data transfer; and
a sensor operatively connected to said controller for sensing data on a living human body as the sensed data.

2. The personal multifunction portable device of claim 1 wherein the clock is operatively connected to said data storage system via said system controller for recording the associated date and/or time of each packet of data stored therein.

3. The personal multifunction portable device of claim 1 wherein the sensor is operatively connected to a transmission means and sending means for sending sensor data obtained from said sensor;
the personal multifunction device further comprising reception means for receiving the sensor data from said transmission means; and
wherein said sensor senses data on a living human body as the sensed data.

4. The personal multifunction portable device of claim 1 wherein the sensor monitors the user's blood pressure, heart rate and/or blood glucose level.

5. The personal multifunction portable device of claim 3 wherein the sensor monitors the user's blood pressure, heart rate, and/or blood glucose level.

6. The personal multifunction portable device of claim 1 further comprising an alarm device for generating an alarm signal that is audible and/or an excessive frequency for generating a vibration alert.

7. The personal multifunction device of claim 6 further comprising:
at least one programmed messages consisting of displayable message text and an associated date and time value indicating when said message text should be communicated to the user of the device and a means for comparing said current date and time indicated by said timing device with the date and time value in said message to actuate an alarm device when a message should be communicated to the user;
an input means operatable by the user for deactivating said alarm device to acknowledge said message.

8. The personal multifunction device of claim 1 further comprising:
at least one programmed sensed data acquisition request and an associated date and time value indicating when said request should be communicated to the sensor and a means for comparing said current date and time indicated by said timing device with the date and time value in said request to actuate the sensor when the user's blood pressure, heart rate, and/or blood glucose level should be acquired;
an event memory for storing event sensed data including the date and time when said data was acquired and storing said data in the device's memory storage system.

9. The personal multifunction device of claim 3 further comprising:
at least one programmed sensed data acquisition request and an associated date and time value indicating when said request should be communicated to the sensor and a means for comparing said current date and time indicated by said timing device with the date and time value in said request to actuate the sensor when the user's blood pressure, heart rate, and/or blood glucose level should be acquired;
an event memory for storing event sensed data including the date and time when said data was acquired and storing said data in the device's memory storage system.

10. The personal multifunction device of claim 1 further comprising a bi-directional communications port for receiving downloaded data from an external source and for transmitting uploaded data to an external device, and an external host computer coupled by a bi-directional communications pathway to said communications port in said device.

11. The personal multifunction device of claim 10 further comprising a means coupled to said bi-directional pathway for transmitting data as downloaded data to the communications port of said personal multifunction device for storage therein,
means coupled to said bi-directional pathway for receiving uploaded data via said pathway from said personal multifunction device, and
an output means for displaying the data derived from said personal multifunction device.

12. The personal multifunction portable device of claim 7 wherein at least one of said messages includes a request for information from the user and wherein said input means operable by said user accepts a response to said request which is recorded as event data which is thereafter stored in the non-volatile memory.

13. The personal multifunction portable device of claim 10 wherein said bi-directional port in said device comprises an infrared emitter and detector and wherein said pathway includes an adapter which houses a corresponding infrared detector and emitter to form a bi-directional infrared communications link.

14. The personal multifunction portable device of claim 10 wherein said bi-directional port in said device comprises a radio frequency transmitter and receiver and wherein said pathway includes an adapter which houses a corresponding radio frequency receiver and transmitter to form a bi-directional radio frequency communications link.

15. The personal multifunction portable device of claim 1 further comprising:
a first host microcomputer with a first memory interface controlled by a first microprocessor including a first data item entry means to the first microprocessor;
the portable device's data storage system having a second memory interface controlled by the device's system controller including a second data entry means to the first microprocessor and a visual display means for showing the data;
a communications link means for communication between the first and second memory interfaces;
a first program in the host microcomputer which transfers data items to the portable device upon command;
a second program in the portable device which collects data using the second dat entry means wherein the data is transferred to the portable device when linked with the host computer by the communications link means and memory interfaces wherein,
the data collected though the user in the portable device using the second data entry means wherein
the second program is run in the portable device and the first program is run in the host microcomputer to transfer the data to the host microcomputer by the communications link means and memory interfaces and transfer the data from the portable device to the host microprocessor.

16. The personal multifunction portable device of claim 15 wherein the communications link is a docking device which utilizes an RS232 cable.

17. The personal multifunction portable device of claim 10 wherein the bi-directional communications link comprises a mobile telephone or a wireless telephone terminal.

18. The personal multifunction portable device of claim 1 wherein the system controller executes a calculator software program for common mathematical computations.

19. The personal multifunction portable device of claim 1 further comprising information pre-loaded and programmable in an electronically erasable programmable read-only memory module.

20. The personal multifunction portable device of claim 1 wherein the system controller includes a personal organizer program for storing calendar information, phone numbers, addresses, contacts, and other personal information.

21. The personal multifunction portable device of claim 10 wherein stock ticker data is transferred through the communications port and stored in the device's data storage system and displayed on the display screen.

22. The personal multifunction portable device of claim 17 wherein the telephone device operates as a pager for receiving text messages and displaying said messages on the display screen.

23. A method of data capture/retrieval of medical patient data using a personal multifunction portable device having a read/write data entry, storage and retrieval portion comprising the steps of:
storing personal identification data in a non-volatile memory of said personal multifunction portable device;
displaying sequentially a tree of data entry menus on a display screen of said personal multifunction portable device;
navigating through said tree of data entry menus and selecting data from said tree of data entry menus by depressing a yes/select or no/don't select switch as the means for controlling passage through the tree of data entry menus, said yes/select and no/don't select switches mounted on said personal multifunction portable device;
entering data selected from said tree of data entry menus by depressing a yes/select switch mounted on said read/write portion to create field entered data; and
storing said field entered data into said non-volatile memory of said personal multifunction portable device.

24. The method of claim 23 further comprising storing in said non-volatile memory the date/time when said field entered data is created.

25. A method of providing patient medical data from a host microcomputer having a memory storage device for storing the data items therein, wherein the data is collected by the user which comprises:
providing the host microcomputer with a first memory interface controlled by a first microprocessor including first data item entry means to the first microprocessor;
a personal multifunction portable device having a second memory interface controlled by a second microprocessor including a second data item entry means to the second microprocessor and a second visual display means for showing the data items;
a communications link means for communication between the first and second memory interfaces;
a first program in the first host microcomputer which transfers data to the personal multifunction portable device upon command;
a second program in the personal multifunction portable device which collects data items using the second data entry means wherein the data items are transferred when linked with the first host microcomputer by the communications link means and memory interfaces;
collecting through the user the data items in the personal multifunction portable device using the second data entry means;
running the second program in the personal multifunction portable device and the first program in the host microcomputer to transfer the data items to the host microcomputer by the communications link means and memory interfaces and to thereby transfer the data of the personal multifunction portable device to the host microcomputer;
running the second program in the personal multifunction portable device and the first program in the host microcomputer to receive data items through the communications link means.
